(19) United States
(12) Patent Application Publication
(10) Pub. No.: US 2020/0050205 A1
(43) Pub. Date: Feb. 13, 2020

(54) SYSTEM AND METHOD FOR UPDATING A MAPPED AREA

(71) Applicant: CNH INDUSTRIAL AMERICA LLC, New Holland, PA (US)

(72) Inventor: Brett Carson McClelland, Chicago, IL (US)

(73) Assignee: CNH INDUSTRIAL AMERICA LLC

(21) Appl. No.: 16/056,995

(22) Filed: Aug. 7, 2018

(51) Int. Cl. G05D 1/02; G01C 21/20

(52) U.S. Cl. CPC G05D 1/0219; G01C 21/20; G05D 2201/0201; G05D 1/0287; G05D 1/0274; G05D 1/0276

(57) ABSTRACT

A controller receives a first set of data indicative of a previously generated map of a work area, such that the previously generated map includes a previous position for each of the previously mapped features within the work area; receives a second set of data indicative of a present position for each of the present features in the work area; match the present features to the previous mapped features to determine at least one offset; determines a percentage of offsets; selectively shifts the previously generated map to establish an updated map of the work area in response to the percentage of offsets exceeding a threshold percentage; and selectively shifts the previously mapped features to establish the updated map in response to the previously mapped features being offset by more than a threshold distance and the percentage of offsets being less than the first threshold percentage.

### BACKGROUND

The present disclosure relates generally to a system and method for updating a mapped area.

Work vehicles (e.g., tractors, harvesters, tow-vehicles, self-propelled implements, self-propelled air-carts, etc.) may perform various tasks in a work area. For example, the work vehicle may park in a stall, couple to an attachment (e.g., implement, front loader, etc.), harvest plants, etc. For autonomous operation, a previously generated map of the work area may facilitate performing these various operations. For example, the work vehicle may access the previously generated map of the work area to identify and locate certain features to engage (e.g., stalls, guidance swaths, etc.), and to identify and locate other features to avoid (e.g., trees, poles, etc.) in the previously mapped work area.

However, in some instances, the previously generated map of the work area may become outdated (e.g., as a result of certain features in the previously mapped work area shifting as a result of certain features in the previously mapped work area moving out of the work area, as a result of certain features moving into the work area, etc.). In addition, manually updating the map may be a tedious, time-consuming, and costly process. For example, an operator may determine the present position of various features in the work area and update the previously generated map of the work area based on the present position of the features.

### BRIEF DESCRIPTION

In one embodiment, a control system for a work vehicle includes a controller, including a processor and a memory device communicatively coupled to the processor and configured to store instructions, wherein the instructions when executed by the processor cause the processor to receive a first set of data indicative of a previously generated map of a work area, such that the previously generated map includes a previous position for each of a plurality of previously mapped features within the work area; receive a second set of data indicative of a present position for each of a plurality of present features in the work area; match the plurality of present features to the plurality of previous mapped features to determine at least one offset between the present position of at least one present feature of the plurality of present features and the previous position of a respective previously mapped feature of the plurality of previously mapped features; determine a percentage of offsets based on a number of offsets of the determined at least one offset having a substantially similar offset distance and the number of the plurality of previously mapped features; selectively shift the previously generated map of the work area to establish an updated map of the work area in response to the percentage of offsets exceeding a first threshold percentage; and selectively shift the each of the plurality of previously mapped features to establish the updated map of the work area in response to the each of the plurality of previously mapped features being offset by more than a threshold distance and the percentage of offsets being less than the first threshold percentage.

In another embodiment, a method for updating a previously generated map of a work area, such that a work vehicle is configured to operate in the work area. The method may be performed by a controller. The method includes receiving a first set of data indicative of the previously generated map of the work area, such that the previously generated map includes a previous position for each of a plurality of previously mapped features within the work area; receiving a second set of data indicative of a present position for each of a plurality of present features in the work area; matching the plurality of present features to the plurality of previous mapped features to determine at least one offset between the present position of at least one present feature of the plurality of present features and the previous position of a respective previously mapped feature of the plurality of previously mapped features; determining a percentage of offsets based on a number of offsets of the determined at least one offset having a substantially similar offset distance and the number of the plurality of previously mapped features; selectively shifting the previously generated map of the work area to establish an updated map of the work area in response to the percentage of offsets exceeding a first threshold percentage; and selectively shifting each of the plurality of previously mapped features to establish the updated map of the work area in response to the each of the plurality of previously mapped features being offset by more than a threshold distance and the percentage of offsets being less than the first threshold percentage.

In a yet another embodiment, a system includes a first work vehicle that includes a first controller and a first sensor assembly, such that the first work vehicle operates in a work area. The system also includes a second work vehicle that includes a second controller and a second sensor assembly, such that the second work vehicle operates in the work area and is communicatively coupled to the first work vehicle. The first controller and second controller receive a first set of data indicative of a previously generated map of a work area, such that the previously generated map includes a previous position for each of a plurality of previously mapped features within the work area; receive a second set of data indicative of a present position for each of a plurality of present features in the work area; match the plurality of present features to the plurality of previous mapped features to determine at least one offset between the present position of at least one present feature of the plurality of present features and the previous position of a respective previously mapped feature of the plurality of previously mapped features; determine a percentage of offsets based on a number of offsets of the determined at least one offset having a substantially similar offset distance and the number of the plurality of previously mapped features; selectively shift the previously generated map of the work area to establish an updated map of the work area in response to the percentage of offsets exceeding a first threshold percentage; and selectively shift each of the plurality of previously mapped features to establish the updated map of the work area in response to the each of the plurality of previously mapped features being offset by more than a threshold distance and the percentage of offsets being less than the first threshold percentage.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of multiple work vehicles within a work area that has been updated to shift the entire work area from a previously mapped position;

FIG. 2 is a schematic diagram of an embodiment of the multiple work vehicles of FIG. 1 within a work area that has been updated to shift one feature from a previously mapped position;

FIG. 3 is a schematic diagram of an embodiment of a control system that may be utilized to control each work vehicle of FIG. 1; and

FIG. 4 is a flowchart of an embodiment of a process for updating a previously generated map of the work area.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time-consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

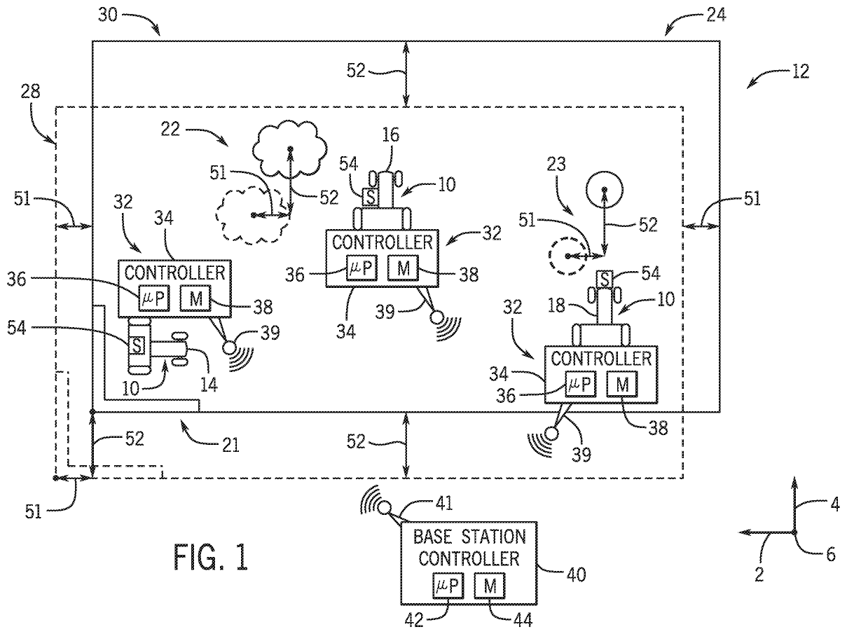

FIG. 1 is a schematic diagram of an embodiment of multiple work vehicles 10 within a work area 12 that has been updated to shift the entire work area 12 from a previously mapped position. In the illustrated embodiment, a first work vehicle 14, a second work vehicle 16, and a third work vehicle 18 (collectively called “the work vehicles 10”) operate in the work area 12. In alternative embodiments, the work area may include one, two, four, five, ten, or any suitable number of work vehicles. Furthermore, in some embodiments, one or more work vehicles 10 perform tasks autonomously (e.g., the work vehicle(s) 10 do not require direct user input to perform operations). However, in alternative embodiments, one or more work vehicles may perform tasks semi-autonomously or manually. The work vehicles 10 (e.g., skid steer, tractor, harvester, excavator, etc.) may travel through the work area 12 to perform various tasks. For example, the first work vehicle 14 may park near a first feature 21 (e.g., a parking area), the second work vehicle 16 may bring harvested crops to a second feature 22 (e.g., a container configured to store harvested crops), and a third work vehicle 16 may avoid a third feature 23 (e.g., a tree, a pole, etc.). In further embodiments, the work area may include one, two, four, five, ten, or any suitable number of features. The features may be geographic features (e.g., a hill, a hole, a tree, etc.), human-built features (e.g., a building, a fence, a garage, etc.), or any other suitable features. Furthermore, in some embodiments, the first, second, and third work vehicles may each engage one or more of the first, the second, the third features.

In some embodiment, a map 24 of the work area 12 is generated to facilitate the operation of the work vehicles 10. The map 24 may include data associated with a position and dimensions of each of the various features (e.g., the first feature 21, the second feature 22, and the third feature 23) in the work area 12. The previously mapped position for the various features and the work area may match the present position of the various features within the work area 12. In some embodiments, the position of the various features and boundaries of the work area 12 may be mapped with respect to a fixed point of reference (e.g., a fixed transceiver). In addition, the work area 12 may be associated with any suitable coordinates, such as global positioning system (GPS) coordinates, spherical coordinates, or projected coordinates (e.g., universal transverse Mercator (UTM), Albers Equal area, Robinson, etc.), and the like. Furthermore, the various features in the work area 12 may be assigned coordinates, such that the map 24 includes a value indicative of the position (e.g., coordinates) of each feature within the work area 12. In some embodiments, the map 24 may enable or facilitate identification of the various features in the work area by control systems associated with the work vehicles 10. For example, it may not be beneficial for the work vehicles to engage with certain features, such as poles, holes, etc., while it may be beneficial for the work vehicles to engage with other features, such as stalls, guidance swaths, etc. Accordingly, maintaining an accurate and updated map 24 of the work area 12 may enhance work vehicle performance.

In the illustrated embodiment, a previously generated map 28 is depicted in dashed-lines. The previously generated map 28 may have been generated any time before the work vehicles 10 operate in the work area 12. For example, the previously generated map 28 may have been created a few hours, days, weeks, months, or years prior to the moment at which the work vehicles 10 operate in the work area 12. In some embodiments, the previously generated map 28 may have been manually generated by an operator. In further embodiments, the previously generated map may have been automatically generated (e.g., by one or more work vehicles 10) using any suitable techniques or systems, such as a sensor assembly and/or a spatial locating device. In some embodiments, the previously generated map 28 may include certain inaccuracies. For example, since the time the previously generated map 28 was created or last updated (e.g., a few hours, days, weeks, months, or years ago), certain features in the previously generated map 28 may have been relocated from the previously mapped positions (e.g., on the previously generated map 28) in the work area 12. Alternatively or additionally, the spatial locating device (e.g., GPS) may have incorrectly determined the position and location of the work area, such that the present position of all features and the boundaries of the work area are offset. In some instances, the offset may be along a lateral axis 2, a longitudinal axis 4, a vertical axis 6, another suitable direction, or any combination thereof. The previously generated map 28 may become outdated as a result of certain features within the work area being relocated or the spatial locating device incorrectly determining the present position of the work area. As used herein, “outdated,” “inaccurate,” or “incorrect,” when used in the context of referring to the previously generated map 28, signifies that the previously generated map 28 of the work area 12 does not accurately represent the present position or coordinates of the boundaries of the work area and/or the present position or coordinates of the features in the work area. In some embodiments, using the techniques described herein to update a previously generated map may establish an accurate map of the work area 12, while reducing computational complexity. For example, in some instances, repositioning certain features in the previously generated map 28 or shifting the entire work area (e.g., every feature and boundary of the work area) in the previously generated map 28 to generate an updated map may utilize less computational resources than generating a new map.

In the illustrated embodiment, the present position of each feature is depicted in solid lines. The position of the features (e.g., the first feature 21, the second feature 22, and the third feature 23) and/or the boundaries of the work area 12 may be mapped to update the previously generated map 28. In some embodiments, boundaries may not be mapped, but updated when map is shifted. In some embodiments, updating the previously generated map 28 may result in creating an updated map 30 of the work area, such that the updated map 30 more correctly represents the present boundaries of the work area 12 and the positions of the various features of the work area 12 (e.g. by repositioning certain features in the previously generated map 28, by shifting the entire previously generated map 28, etc.). As described in detail below, updating the previously generated map 28 to generate the updated map 30 may be based on one or more differences between a first set of data indicative of the previously generated map 28 and a second set of data indicative of the present positions or coordinates of the features in the work area 12.

In the illustrated embodiment, the work vehicles 10 each include a control system 32, which includes a vehicle controller 34 that may be configured to implement the techniques described herein. In certain embodiments, the vehicle controller 34 is an electronic controller having electrical circuitry configured to process data. In the illustrated embodiment, the vehicle controller 34 includes a processor, such as the illustrated microprocessor 36, and a memory device 38. The vehicle controller 34 may also include one or more storage devices and/or other suitable components. The microprocessor 36 may be used to execute software, such as software for controlling the work vehicle 10, receiving the first set of data indicative of the previously generated map 28, updating the previously generated map 28 to create the updated map 30, and the like. Moreover, the microprocessor 36 may include multiple microprocessors, one or more “general-purpose” microprocessors, one or more special-purpose microprocessors, and/or one or more application-specific integrated circuits (ASICS), or some combination thereof. For example, the microprocessor 36 may include one or more reduced instruction set (RISC) processors.

The memory device 38 may include a volatile memory, such as random-access memory (RAM), and/or a nonvolatile memory, such as read-only memory (ROM). The memory device 38 may store a variety of information and may be used for various purposes. For example, the memory device 38 may store processor-executable instructions (e.g., firmware or software) for the microprocessor 36 to execute, such as instructions for controlling the work vehicle 10, receiving the first set of data indicative of the previously generated map 28, updating the previously generated map 28 to create the updated map 30, and the like. The storage device(s) (e.g., nonvolatile storage) may include ROM, flash memory, a hard drive, or any other suitable optical, magnetic, or solid-state storage medium, or a combination thereof. The storage device(s) may store data (e.g., the first set of data indicative of the previously generated maps), instructions (e.g., software or firmware for controlling the work vehicle, updating the previously generated map 28 to create the updated map 30, etc.), and any other suitable data.

Furthermore, the vehicle controller 34 may include a first transceiver 39 configured to wirelessly communicate with a base station controller 40. In some embodiments, the first transceiver 39 may (e.g., wirelessly) communicate with a second transceiver 41 of the base station controller 40. In certain embodiments, the base station controller 40 is an electronic controller having electrical circuitry configured to process data, for example from the work vehicle(s) 10. In the illustrated embodiment, the base station controller 40 includes a processor, such as the illustrated microprocessor 42, and a memory device 44. The processor 42 may be used to execute software, such as software for providing commands and/or data to the base station controller 40, and so forth. Moreover, the processor 42 may include multiple microprocessors, one or more “general-purpose” microprocessors, one or more special-purpose microprocessors, and/or one or more application-specific integrated circuits (ASICS), or some combination thereof. For example, the processor 42 may include one or more reduced instruction set (RISC) processors. The memory device 44 may include a volatile memory, such as RAM, and/or a nonvolatile memory, such as ROM. The memory device 44 may store a variety of information and may be used for various purposes. For example, the memory device 44 may store processor-executable instructions (e.g., firmware or software) for the processor 42 to execute, such as instructions for providing commands and/or data to the vehicle controller 34. However, in further embodiments, the base station controller 40 may be omitted.

In the illustrated embodiment, the positions or coordinates of the features in the previously generated map 28 are offset from the present positions or coordinates of the features. In addition, the boundaries are offset. In the illustrated embodiment, the features and boundaries of the previously generated map 28 are offset by a lateral offset 51 (e.g., offset along the lateral axis 2) and a longitudinal offset 52 (e.g., offset along the longitudinal axis 4) from the present positions of the features and boundaries. In the illustrated embodiment, the first feature 21, the second feature 22, and the third feature 23, as well as the boundaries of the work area 12 in the previously generated map 28, are offset relative to the respective present positions by distances corresponding to the first lateral offset 51 and the second longitudinal offset 52. Although in the illustrated embodiment, features and boundaries of the previously generated map 28 are offset from the present positions or coordinates of the features and boundaries by the first lateral offset 51 and the second longitudinal offset 52, in further embodiments, the previous positions or coordinates of the features and/or the work area boundaries on the previously generated map may be offset from the present positions or coordinates of the features and/or work area boundaries by a displacement of any magnitude along any direction (e.g., the lateral axis, the longitudinal axis, the vertical axis, etc.).

In the illustrated embodiment, each work vehicle 10 includes a sensor assembly 54 configured to facilitate determination of the second set of data indicative of the positions or coordinates of the present features in the work area 12. For example, the sensor assembly 54 may include one or more sensors (e.g., infrared sensors, ultrasonic sensors, magnetic sensors, radar sensors, Lidar sensors, terahertz sensors, etc.) positioned on the work vehicle 10. In further embodiments, the sensor assembly 54 may include sensors positioned in the work area and communicatively coupled to the vehicle controller and/or the base station controller. In certain embodiments, the sensor assembly 54 is configured to monitor a position of various features proximate the work vehicle 10. Furthermore, the sensor assembly 54 may monitor a rotation rate of a respective wheel or track, monitor a position and ground speed of the work vehicle 10, etc. The sensor assembly 54 may also monitor operating levels (e.g., temperature, fuel level, etc.) of the work vehicle 10. Furthermore, the sensors (e.g., of the sensor assembly 54) may monitor conditions in and around the work area, such as temperature, weather, wind speed, humidity, and other conditions. In addition, the sensors may detect physical objects in the work area, such as the first feature 21, the second feature 22, the third feature 23, other vehicles, other obstacles, and/or other object(s) in the area surrounding the work vehicle. Detecting the physical objects in the work area may be used to determine the second set of data indicative of the positions or coordinates of the present features in the work area.

In the illustrated embodiment, the first work vehicle 14 detects the position or coordinates of the first feature 21, the second work vehicle 16 detects the position or coordinates of the second feature 22, and the third work vehicle 18 detects the position or coordinates of the third feature 23. However, in further embodiments, any of the work vehicles 10 may detect the position of any features or work area characteristics (e.g., boundaries) (e.g., with the sensor assembly 54) to determine the second set of data. For example, the work area 12 may include only the first work vehicle 14, which may detect the features and determine the second set of data indicative of the present positions or coordinates of the features in the work area 12. In some embodiments, the work vehicle may detect dimensions associated with a feature. For example, the previously generated map 28 may include a tree as the first feature 21, such that the tree may grow in circumference and have different dimensions than those included in the previously generated map 28.

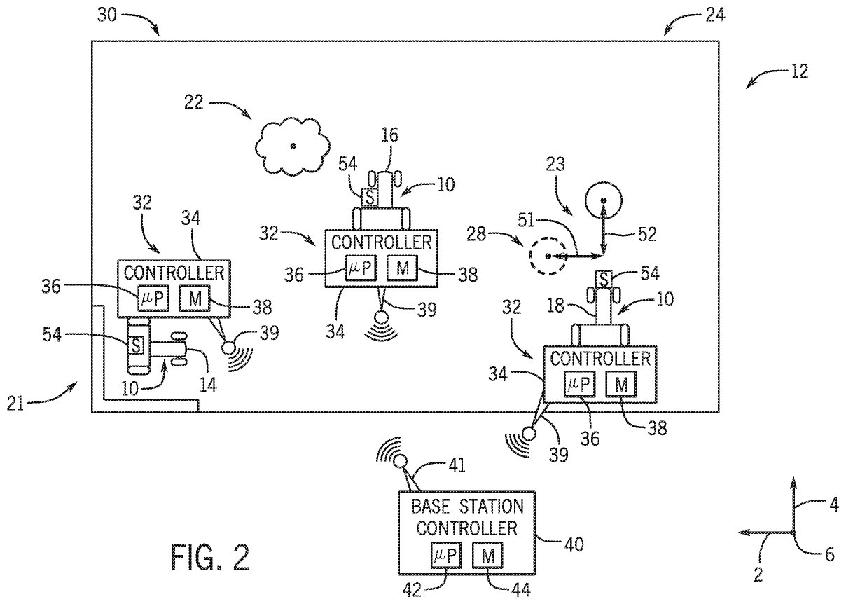

As discussed in detail below, the vehicle controller 34 may receive the first set of data indicative of the previously generated map 28 and the second set of data indicative of the present position(s) and/or coordinates of the feature(s) in the work area 12. For example, the first set of data may be stored in the memory devices 38 and the second set of data may be determined by the vehicle controller 34 based on information from the sensor assembly/assemblies 54, as discussed above. The vehicle controller 34 may compare the first set of data to the second set of data to determine one or more differences between the first set of data and the second set of data. For example, the vehicle controller 34 may compare the present position or coordinates of each feature on the field (e.g., from the second set of data) to the corresponding position or coordinates of the feature stored in the previously generated map 28 (e.g., from the first set of data). In some embodiments, the vehicle controller 34 may update the previously generated map based on the comparison. Updating the previously generated map may include repositioning (e.g., translating along the lateral axis, the longitudinal axis, the vertical axis, etc.) the entire work area (e.g., all features and boundaries) of the previously generated map 28, as shown in FIG. 1. In some embodiments, repositioning the entire work area may be facilitated by shifting the boundaries of the work area of the previously generated map 28. Additionally or alternatively, updating the previously generated map 28 may include repositioning (e.g., translating along the lateral axis, the longitudinal axis, the vertical axis, etc.) one or more features within the previously generated map 28, as discussed below with regard to FIG. 2. In some embodiments, updating the previously generated map 28 includes generating the updated map 30 (e.g., by correcting the previously generated map 28) to more closely align with the second set of data.

In the illustrated embodiment, the work vehicle(s) 10 may detect (e.g., via the sensor assembly/assemblies 54), as the second set of data, the present positions or coordinates of the various features (e.g., the first feature 21, the second feature 22, and the third feature 23) and, in certain embodiments, the present boundaries of the work area 12. The vehicle controller 34 may receive the second set of data and compare the present position or coordinates to the previous position and coordinates of the corresponding features and/or boundaries. In the illustrated embodiment, the vehicle controller 34 may determine that the present positions or coordinates of the first feature 21, the second feature 22, the third feature 23, and the boundaries of the work area 12 are each offset by the first lateral offset 51 and the second longitudinal offset 52 relative to the corresponding positions or coordinates of the previously generated map 28 (e.g., associated with the first set of data). As a result, the vehicle controller 34 may update the previously generated map by shifting the features and boundaries of the previously generated map along the lateral direction 2 to correct for the first lateral offset 51 and along the longitudinal direction 4 to correct for the second longitudinal offset 52.

In some embodiments, the boundaries of the work area may be difficult to detect. In such embodiments, when the work vehicle 10 detects that all features are offset from their previous positions or coordinates by the same distance, the vehicle controller 34 may update the previously generated map 28 by shifting the previous boundary and all associated features by the distance the features are offset. In some embodiments, instead of all features being offset from their previous positions or coordinates by the same distance, the vehicle controller 34 may update the previously generated map 28 by shifting the previous boundary and all associated features by the distance the features are offset in response to a percent of features being offset by substantially the same distance offset. For example, the vehicle controller 34 may shift all associated features in response to 50%-100% of features being offset by substantially the same distance offset, such that the features are determined to be offset by substantially the same distance offset in response to the distance offset corresponding to a plurality of features varying less than 25%. While percentage values are provided herein to facilitate discussion, these ranges of percentages are not meant to be limiting and may be adjusted (e.g., increased or decreased) to personalize the application of the embodiments disclosed herein.

In some embodiments, the vehicle controller 34 may determine that more than a threshold number of features are offset by substantially similar offsets (e.g., the first lateral offset 51 and the second lateral offset 52). As discussed above, in some embodiments, the features are determined to be offset by substantially the same distance offset in response to the distance offset corresponding to a plurality of features varying less than 25%. The vehicle controller 34 may update the previously generated map by shifting the features and boundaries to correct for the offsets, for example, in response to determining that the first, second, and third features 21, 22, 23, each have substantially similar offsets. In other words, if the number of features having similar offsets exceeds a threshold value (e.g., in this case, three), the previously generated map is modified by shifting the features and boundaries to correct for the offset. In some embodiments, the threshold value may be based on a percentage of features. For example, the vehicle controller 34 may shift all associated features in response to 50%-100% of features being offset by substantially the same distance offset. While in the illustrated embodiment, the threshold value of features is three features, in further embodiments, the threshold value of features may be two, four, five, ten, twenty, one-hundred, etc., and may be based on a percentage of the total features. Updating the previously generated map 28 may produce the updated map 30, depicted in FIG. 1 with solid lines. The updated map 30 may include coordinates or positions for the various features in the work area and work area boundaries closer to the present positions or coordinates of the various features and boundaries of the work area 12.

FIG. 2 is a schematic diagram of an embodiment of the multiple work vehicles 10 of FIG. 1 within a work area 12 that has been updated to shift one feature from a previously mapped position. In the illustrated embodiment, the work area 12 and various features (e.g., the first feature 21, the second feature 22, the third feature 23, etc.) in the work area 12 are mapped onto a previously generated map 31. The vehicle controller 34 may receive the first set of data indicative of the positions or coordinates of the features previously mapped in the work area 12 (e.g., the first feature 21, the second feature 22, the third feature 23, and the positions or coordinates of the boundaries of the work area). In the illustrated embodiment, the previous position or coordinates of the third feature 23 (e.g., in the previously generated map 31) is offset from the present position and/or coordinates of the third feature 23. To facilitate discussion, the position of the third feature 23 as mapped in the previously generated map 31 is depicted with dashed lines. In addition, the present positions of the various features are depicted with solid lines. As such, in the illustrated embodiment, only the third feature 23 in the previously generated map 31 has been offset, while the coordinates or positions of the other features (e.g., the first feature 21, the second feature 22) and the boundaries of the work area 12 in the previously generated map 31 are not offset from their respective present positions or coordinates.

In the illustrated embodiment, the third feature 23 is shifted on the previously generated map 31, for example, because the vehicle controller 34 receives the second set of data and determines that the present position or coordinates of the third feature 23 is not substantially similar to the previous position or coordinates. In some embodiments, the vehicle controller 34 may update the previous position or coordinates of the third feature 23 in response to determining that the third feature 23 is not within acceptable tolerances. For example, the tolerances may be based on a percent deviation from the position or coordinates of the previously generated map 31, such that the feature is not within an acceptable tolerance if the position or coordinates of the previously generated map 31 deviate more than a threshold distance or a percent of the threshold distance.

In the illustrated embodiment, the sensor assembly/assemblies 54 may detect the present position or coordinates of each feature in the work area 12. The detected present position or coordinates of the various features in the work area 12 may be received by the vehicle controller 34 as the second set of data. The vehicle controller 34 may compare the present position or coordinates of each feature on the field (e.g., from the second set of data) to the corresponding position or coordinates of the feature stored in the previously generated map 28 (e.g., from the first set of data). The vehicle controller 34 may update the previously generated map to generate the updated map 30. In the illustrated embodiment, the vehicle controller 34 may compare the first set of data and the second set of data to determine that the position or coordinates of the third feature is the only difference between the positions or coordinates of the features in the previously generated map 31 and the present positions or coordinates of the corresponding features. In the illustrated embodiment, only the third feature is offset by the first lateral offset 51 and the second longitudinal offset 52. For example, since the previously generated map 31 was last updated, the third feature (e.g., a rigid structure, such as a tree) may have been repositioned (e.g., a tree may have fallen) such that the third feature now occupies a different position or coordinates in the present work area 12. Accordingly the vehicle controller 34 may update the map by repositioning only the feature(s) that have been offset (i.e., the third feature in the present embodiment).

In some embodiments, the vehicle controller 34 may update the previously generated map 31 by repositioning only the feature(s) having present positions or coordinates that differ from the previous positions or coordinates when the number of offset features does not exceed a threshold number of features. For example, because only one feature (i.e., the third feature 23) has been offset (e.g., by the first lateral offset 51 and the second lateral offset 52) and one feature is less than a threshold number of features, the vehicle controller 34 only repositions the one feature on the updated map. As such, in the illustrated embodiment, the updated map 30 may differ from the previously generated map 31 in that the third feature 23 is repositioned to correct for the first lateral offset 51 and the second longitudinal offset 52. In some embodiments, updating the previously generated map includes modifying the previously generated map such that the positions of the features more closely match the positions of the features in the second set of data. Alternatively or additionally, updating the previously generated map may include reducing the feature position differences between the first set of data and the second set of data.

While FIG. 1 includes shifting the location of the entire work area 12 to update the previously generated map to create the updated map 30, and while FIG. 2 includes repositioning certain feature(s) within the previously generated map to update the previously generated map 31 and create the updated map 30, in further embodiments, the vehicle controller 34 may shift the location of the entire work area 12 and also reposition certain features. Furthermore, the vehicle controller 34 may update the map by performing any suitable actions, such as scaling the previously generated map 31, removing certain features of the previously generated map, adding features to the map, and the like. In some embodiments, a base station controller and/or the vehicle controller 34 may receive the first and second sets of data to update the previously generated map based on a comparison of the present position or coordinates of each feature on the field (e.g., from the second set of data) to the corresponding position or coordinates of the feature stored in the previously generated map 28 (e.g., from the first set of data).

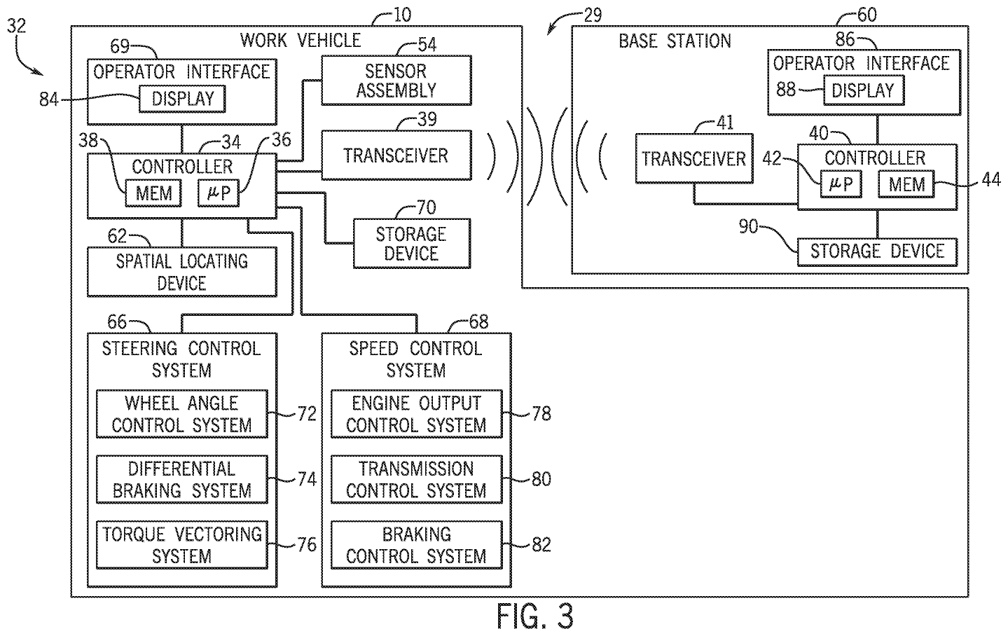

FIG. 3 is a schematic diagram of an embodiment of a control system 29 that may be utilized to control each work vehicle 10 of FIG. 1. In the illustrated embodiment, the control system 29 includes the vehicle control system 32 (e.g., mounted on the work vehicle 10) and a base station control system 60. The vehicle control system 32 includes the first transceiver 39 configured to establish a wireless communication link with the second transceiver 41 of the base station control system 60. The first and second transceivers may operate at any suitable frequency range within the electromagnetic spectrum. For example, in certain embodiments, the transceivers may broadcast and receive radio waves within a frequency range of about 1 GHz to about 10 GHz. In addition, the first and second transceivers may utilize any suitable communication protocol, such as a standard protocol (e.g., Wi-Fi, Bluetooth, etc.) or a proprietary protocol.

In the illustrated embodiment, the vehicle control system 32 includes a spatial locating device 62, which is mounted to the work vehicle 10 and configured to determine a position of the work vehicle 10. The spatial locating device 62 may include any suitable system configured to determine the position of the work vehicle 10, such as a global positioning system (GPS) receiver, for example. In certain embodiments, the spatial locating device 62 may be configured to determine the position of the work vehicle 10 relative to a fixed point within the field (e.g., via a fixed radio transceiver). Accordingly, the spatial locating device 62 may be configured to determine the position of the work vehicle 10 relative to a fixed global coordinate system (e.g., via the GPS) or a fixed local coordinate system, as described above. In certain embodiments, the first transceiver 39 is configured to broadcast a signal indicative of the position of the work vehicle 10 to the second transceiver 41 of the base station control system 60. Using the position of the work vehicle 10 during traversal of the work area, a map of the work area may be generated or updated with the techniques described herein. The map may enable the vehicle controller 34 to determine the position of various features before detection by the sensor assembly 54 of the work vehicle 10. For example, as the work vehicle 10 travels through a portion of the work area, the control system 29 may generate a map of the work area by utilizing data from the sensor assembly 54 and the spatial locating device 62, among other devices of the work vehicle 10, to detect the present positions or coordinates of the features (e.g., obstacles, docking locations, etc.) in the work area.

In some embodiments, the vehicle controller 34 receives the position of features in a work area relative to the position of the work vehicle 12. The vehicle controller 34 may determine the respective position of the features in the field based on a relative position and the position of the work vehicle 12. As described above, the present positions or coordinates of the features in the work area may be received by the vehicle controller 34 as the second set of data. Further, the sensor assembly 54 may additionally detect a shape, size, dimension, etc. of the features in the work area. In some embodiments, the map includes the position or coordinates of features and the dimensions of the features.

In addition, the vehicle control system 32 includes the sensor assembly 54. In certain embodiments, the sensor assembly 54 is configured to output the second set of data indicative of the positions or the coordinates of the present features in the work area, as discussed above. Furthermore, the sensor assembly 54 may output data indicative of condition(s) of the work vehicle 10 and/or the work area 12. For example, the sensor assembly 54 may include multiple sensors (e.g., infrared sensor(s), ultrasonic sensor(s), magnetic sensor(s), radar sensor(s), Lidar sensor(s), terahertz sensor(s), etc.) configured to monitor positions of various features proximate the work vehicle 10, monitor a rotation rate of a respective wheel or track, monitor a position and ground speed of the work vehicle 10, etc. The sensors of the sensor assembly 54 may also monitor operating levels (e.g., temperature, fuel level, etc.) of the work vehicle 10. Furthermore, the sensors may monitor conditions in and around the work area, such as temperature, weather, wind speed, humidity, and other conditions. In addition, the sensors may detect physical objects in the work area, such as the first feature, the second feature, the third feature, other vehicles, other obstacles, other object(s), or a combination thereof, which may be in the area surrounding the work vehicle 10. Furthermore, the sensor assembly 54 is communicatively coupled to the vehicle controller 34 to communicate information (e.g., the second set of data, etc.) to vehicle controller 34. In some embodiments, the sensor assembly 54 may communicate information to the base station control system 60 via the vehicle controller 34. In other embodiments, the sensor assembly 54 on the work vehicle 12 may communication information to the base station controller via respective transceivers 39, 41. In other embodiments, the sensor assembly 54 may be positioned on the work field 12 and communicate information to the vehicle controllers 34 and/or the base station controller 40.

In some embodiments, the vehicle controller 34 of a first work vehicle may match the position or coordinates of an object as determined by the first work vehicle to the position or coordinates of a second work vehicle. When the position or coordinates of the object determined by the first work vehicle match the position or coordinates of the second vehicle, the object is not added to the updated map because the second work vehicle is not a feature of the work area. As such, the work vehicles may not add each other to the updated map while they scan the work area to update the map of the work area based on identified differences.

In the illustrated embodiment, the work vehicle 10 includes a movement control system that includes a steering control system 66 configured to control a direction of movement of the work vehicle 10 and a speed control system 68 configured to control a speed of the work vehicle 10. The vehicle controller 34 is communicatively coupled to the first transceiver 39, the spatial locating device 62, the sensor assembly 54, the steering control system, the speed control system 68, an operator interface 69, and a storage device 70. In certain embodiments, the vehicle controller 34 is configured to receive a position of the work vehicle 10 (e.g., from a spatial locating device) and to instruct the vehicle to move based at least in part on the position of the work vehicle 10. Further, the vehicle controller 34 may receive a task to be completed by the work vehicle 10 and create a plan that includes a route for the work vehicle 10 to follow. The vehicle controller 34 may additionally or alternatively receive the task or plan from the base station controller 40.

In certain embodiments, the vehicle controller 34 is an electronic controller having electrical circuitry configured to process data from the first transceiver 39, the spatial locating device 62, the sensor assembly 54, or a combination thereof, among other components of the work vehicle 10. In the illustrated embodiment, the vehicle controller 34 includes a processor, such as the illustrated microprocessor 36, and the memory device 38. The vehicle controller 34 may also include other suitable components. The microprocessor 36 may be used to execute software, such as software for controlling the work vehicle 10, and so forth. Moreover, the microprocessor 36 may include multiple microprocessors, one or more “general-purpose” microprocessors, one or more special-purpose microprocessors, and/or one or more ASICS, or some combination thereof. For example, the microprocessor 36 may include one or more RISC processors.

The memory device 38 may include a volatile memory, such as RAM, and/or a nonvolatile memory, such as ROM. The memory device 38 may store a variety of information and may be used for various purposes. For example, the memory device 38 may store processor-executable instructions (e.g., firmware or software) for the microprocessor 36 to execute, such as instructions for controlling the work vehicle 10. The storage device(s) 70 (e.g., nonvolatile storage) may include ROM, flash memory, a hard drive, or any other suitable optical, magnetic, or solid-state storage medium, or a combination thereof. The storage device(s) 70 may store data (e.g., the previously generated maps), instructions (e.g., software or firmware for controlling the work vehicle, for modifying the previously generated map(s), etc.), and any other suitable data.

In the illustrated embodiment, the steering control system 66 includes a wheel angle control system 72, a differential braking system 74, and a torque vectoring system 76. The wheel angle control system 72 may automatically rotate one or more wheels or tracks of the work vehicle 10 (e.g., via hydraulic actuators) to steer the work vehicle 10 along a target route (e.g., around mapped features in the work area). By way of example, the wheel angle control system 72 may rotate front wheels/tracks, rear wheels/tracks, and/or intermediate wheels/tracks of the work vehicle, either individually or in groups. In certain embodiments, the work vehicle includes a front portion having front wheel/tracks and a rear portion having rear wheels/tracks, in which the front and rear portions of the work vehicle are coupled to one another by a pivot joint, thereby forming an articulated work vehicle. In such embodiments, the wheel angle control system may rotate the rear portion of the work vehicle relative to the front portion to steer the work vehicle along the target route. The differential braking system 74 may independently vary the braking force on each lateral side of the work vehicle to direct the work vehicle along the path through the field. Similarly, the torque vectoring system 76 may differentially apply torque from the engine to wheels and/or tracks on each lateral side of the work vehicle, thereby directing the work vehicle along the path through the field. While the illustrated steering control system 66 includes the wheel angle control system 72, the differential braking system 74, and the torque vectoring system 76, it should be appreciated that alternative embodiments may include one or more of these systems, in any suitable combination. Further embodiments may include a steering control system having other and/or additional systems to facilitate directing the work vehicle through the work area (e.g., an articulated steering system, etc.).

In the illustrated embodiment, the speed control system 68 includes an engine output control system 78, a transmission control system 80, and a braking control system 82. The engine output control system 78 is configured to vary the output of the engine to control the speed of the work vehicle 10. For example, the engine output control system 78 may vary a throttle setting of the engine, a fuel/air mixture of the engine, a timing of the engine, and/or other suitable engine parameters to control engine output, or a combination thereof. In addition, the transmission control system 80 may adjust an input-output ratio within a transmission to control the speed of the work vehicle. Furthermore, the braking control system 82 may adjust braking force, thereby controlling the speed of the work vehicle 10. While the illustrated speed control system 68 includes the engine output control system 78, the transmission control system 80, and the braking control system 82, alternative embodiments may include one or two of these systems, in any suitable combination. Further embodiments may include a speed control system having other and/or additional systems to facilitate adjusting the speed of the work vehicle.

In the illustrated embodiment, the work vehicle 10 includes the operator interface 69 communicatively coupled to the vehicle controller 34. The operator interface 69 is configured to present data from one or more work vehicles 10 to an operator (e.g., data associated with features surrounding the work vehicle(s), data associated with the types of features surrounding the work vehicle(s), data associated with operation of the work vehicle(s), data associated with the plan of the work vehicle(s), etc.). The operator interface 69 may also enable the operator to input information about the work area and/or the plan that may enable the vehicle controller 34 to determine courses of action for the work vehicle 10. The operator interface 69 is also configured to enable an operator to control certain functions of the work vehicle(s) (e.g., starting and stopping the work vehicle(s), instructing the work vehicle(s) to follow a route through the work area, etc.). In the illustrated embodiment, the operator interface 69 includes a display 84 configured to present information to the operator, such as the position of the work vehicle(s) within the field, the speed of the work vehicle(s), the path(s) of the work vehicle(s), and the previously generated map of the work area, the updated map of the work area among other data. The display 84 may be configured to receive touch inputs, and/or the operator interface 69 may include other input device(s), such as a keyboard, mouse, or other human-to-machine input device(s). In addition, the operator interface 69 (e.g., via the display 84, via an audio system, etc.) may be configured to notify the operator of the plan and/or travel path of the work vehicle, the modifications made to the previously generated map, and the like.

As previously discussed, the vehicle control system 32 is configured to communicate with the base station control system 60 via the first transceiver 39 and the second transceiver 41. In the illustrated embodiment, the base station control system 60 includes the base station controller 40, which is communicatively coupled to the second transceiver 41. The base station controller 40 is configured to output commands and/or data to the work vehicle 10. For example, the base station controller 40 may be configured to determine a present position of the various features within the work area (e.g., including objects that may impede a path of the work vehicle(s), etc.) and/or the route of the work vehicle(s) through the work area. The base station controller 40 may also compare the positions or coordinates of the various features mapped in the previously generated map of the work area to the present positions or coordinates of the various features within the work area to update the previously generated map. In some embodiments, the base station controller 40 may output instructions indicative of the route of each work vehicle to the vehicle controller 34, thereby enabling the vehicle controller 34 to direct the work vehicle 10 though the work area. In some embodiments, the base station controller 40 may determine the route based on the plan, the updated map of the work area, the position(s) of the work vehicle(s) 10, and the like. In some embodiments, the base station controller 40 outputs the previously generated map and/or the updated map, and the vehicle controller 34 determines the route based on the received plan, the map of the work area, the position of the work vehicle 10, and the like. In addition, the base station controller 40 may output start and stop commands to each vehicle controller 34.

In certain embodiments, the base station controller 40 is an electronic controller having electrical circuitry configured to process data from certain components of the base station control system 60 (e.g., the second transceiver 41). In the illustrated embodiment, the base station controller 40 includes a processor, such as the illustrated microprocessor 42, and the memory device 44. The processor 42 may be used to execute software, such as software for updating a previously generated map, and so forth. Moreover, the processor 42 may include multiple microprocessors, one or more “general-purpose” microprocessors, one or more special-purpose microprocessors, and/or one or more ASICS, or some combination thereof. For example, the processor 42 may include one or more RISC processors. The memory device 44 may include a volatile memory, such as RAM, and/or a nonvolatile memory, such as ROM. The memory device 44 may store a variety of information and may be used for various purposes. For example, the memory device 44 may store processor-executable instructions (e.g., firmware or software) for the processor 42 to execute, such as instructions for updating a previously generated map.

In the illustrated embodiment, the base station control system 60 includes an operator interface 86 communicatively coupled to the base station controller 40. The operator interface 86 is configured to present data from one or more vehicle control system to an operator (e.g., data associated with objects surrounding the work vehicle(s) 10, data associated with the types of objects surrounding the work vehicle(s) 10, data associated with the previously generated map, data associated with the present position and/or coordinates of the features in the work area, data associated with operation of the work vehicle(s) 10, data associated with the plan(s) of the work vehicle(s) 10, etc.). The operator interface 86 may also enable the user to input information about the work area and/or the plan that may enable the base station controller 40 to determine further courses of action for the work vehicle(s). The operator interface 86 is also configured to enable an operator to control certain functions of the work vehicle(s) 10 (e.g., starting and stopping the work vehicle(s), instructing the work vehicle(s) 10 to follow route(s) through the work area, etc.). In the illustrated embodiment, the operator interface 86 includes a display 88 configured to present information to the operator, such as the position of the work vehicle(s) 10 within the work area, the updated map, the speed of the work vehicle(s) 10, and the path(s) of the work vehicle(s) 10, among other data. The display 88 may be configured to receive touch inputs, and/or the operator interface 86 may include other input device(s), such as a keyboard, mouse, or other human-to-machine input device(s). In addition, the operator interface 86 (e.g., via the display 88, via an audio system, etc.) may be configured to notify the operator of the modifications to the previously generated map, the plan(s) and travel path(s) of the work vehicle(s) 10, and the like.

In the illustrated embodiment, the base station control system 60 includes a storage device 90 communicatively coupled to the base station controller 40. The storage device 90 (e.g., nonvolatile storage) may include ROM, flash memory, a hard drive, or any other suitable optical, magnetic, or solid-state storage medium, or a combination thereof. The storage device(s) 90 may store data (e.g., previously generated map(s) of the work area), instructions (e.g., software or firmware for modifying the previously generated map(s), etc.), and any other suitable data.

While the vehicle control system 32 of the control system 29 includes the vehicle controller 34 in the illustrated embodiment, in alternative embodiments, the vehicle control system 32 may include the base station controller 40. For example, in certain embodiments, control functions of the vehicle control system 32 may be distributed between the vehicle controller 34 and the base station controller 40. In further embodiments, the base station controller 40 may perform a substantial portion of the control functions of the vehicle control system 32. Any processes of the vehicle controller 34 and the base station controller 40 may be allocated to either controller in at least some embodiments. For example, the base station control system 60 may be omitted, and components of the base station control system 60 may also be omitted or distributed among the vehicle control system 32 and any other suitable control system. Furthermore, at least part of the processes described herein may be performed via a cloud-based service or other remote computing system, and such computing is considered part of the vehicle control system 32.

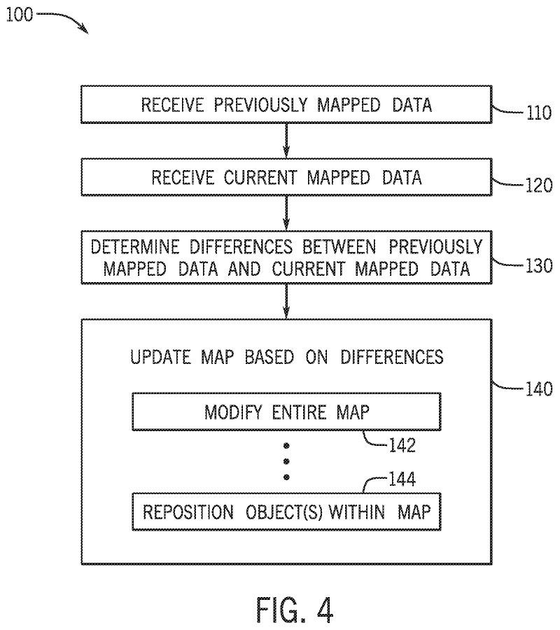

FIG. 4 is a flowchart of an embodiment of a process 100 for updating a previously generated map of the work area. The process 100 enables vehicle control system to autonomously update a previously generated map based on a comparison of the present position or coordinates and the previous position and coordinates of the corresponding features and/or boundaries. Although the following process 100 includes a number of operations that may be performed, it should be noted that the process 100 may be performed in a variety of suitable orders (e.g., the order that the operations are discussed, or any other suitable order). At least one of the operations of the process 100 may not be performed. Further, all of the operations of the process 100 may be performed by the vehicle controller, the base station controller, or a combination thereof.

The vehicle controller is configured to receive previously mapped data (process block 110). As mentioned above, the vehicle controller may receive the first set of data indicative of the previously generated map of the work area (process block 110). The previously generated map may be generated at any time prior to the work vehicle(s) presently operating in the work area. For example, the previously generated map may be created a few hours, days, weeks, months, or years prior to the work vehicle(s) operating in the work area. In some embodiments, the previously generated map may be manually generated by an operator. In further embodiments, the previously generated map may be automatically generated (e.g., by one or more vehicle control systems) via any suitable techniques using any suitable systems, such as the sensor assembly and/or spatial locating device of the work vehicle, as discussed in detail above. Furthermore, in some embodiments, the previously generated map of the work area may be stored in the memory device or storage device (e.g., of the vehicle controller and/or of the base station controller). The first set of data indicative of the previously mapped data may be received from the memory device or the storage device, for example.

Furthermore, the vehicle controller is configured to receive (process block 120) presently (e.g., currently) mapped data. As mentioned above, the vehicle controller may receive (process block 120) the second set of data indicative of the present position and/or coordinates of the features in the work area, for example, via the sensor assembly. In some embodiments, the positions or coordinates of the features may be determined based on feedback (e.g., the second set of data) from the sensor assembly and the spatial locating device of the work vehicle. In some embodiments, the spatial locating device may be configured to determine the position or coordinates of the work vehicle, for example, relative to a fixed point within the field (e.g., via a fixed radio transceiver) or relative to a fixed global coordinate system (e.g., via the GPS). Furthermore, the sensor assembly may detect features in proximity to sensors of the sensor assembly. For example, the sensor assembly may detect the first feature, the second feature, and the third feature of FIGS. 1 and 2, and the spatial locating device may facilitate associating a position or coordinates to the detected first, second, and third features.

The vehicle controller may determine (process block 130) one or more differences between the previously mapped data (process block 110) and the presently mapped data (process block 120). As discussed above, in some instances, the previously generated map may include certain inaccuracies since last updated. For example, since the time the previously generated map was created or last updated (e.g., a few hours, days, weeks, months, or years ago), certain features in the previously generated map may have been relocated, removed, or added with respect to the work area. Alternatively or additionally, the entire previously generated map may have shifted, such that the present position and/or coordinates of the features and the work area are inaccurate. In some instances, the offset may be along any suitable direction (e.g., the lateral axis, the longitudinal axis, the vertical axis, etc.). The vehicle controller (and/or the base station controller) is configured to determine any of these difference(s) between the previous position or coordinates and the present position and coordinates.

When there is one or more differences between the previous positions or coordinates and the current positions or coordinates, the vehicle controller updates (process block 140) the previously generated map based on the differences. In some embodiments, updating (process block 140) the previously generated map reduces the one or more differences based on the comparison of the previous positions or coordinates and the current positions or coordinates. Modifying the previously generated map to correct for the determined one or more differences may generate an updated map. In some embodiments, the updated map more closely matches the present position and/or coordinates of the features in the work area.

As mentioned above, updating the previously generated map may include shifting (process block 142) the entire previously generated map of the work area. For example, vehicle controller may determine that the present position or coordinates of many features in the work area differ from the previous position and/or coordinates (e.g., in the previously generated map) of the many features. In response, the vehicle controller may modify (process block 142) the entire previously generated map by shifting the previously generated map to more closely match the present position and/or coordinates of the features. For example, as illustrated in FIG. 1, updating the previously generated map may include repositioning (e.g., translating along the lateral, longitudinal, or vertical direction) the previously generated map in response to determining that the previous position or coordinate of the various features each differ from the present position and/or coordinates by similar amounts. As discussed above, in some embodiments, when the number of features offset by a substantially similar distance offset exceeds a threshold value, updating the previously generated map may include modifying the previously generated map by shifting the entire work area to correct for the offset. Updating the previously generated map may produce the updated map. The updated map may include present positions and coordinates for the various features in the work area, such that the present positions and coordinates more close match the present position of the various features presently in the work area.

In some embodiments, updating the previously generated map may include repositioning (process block 144) certain features (e.g., objects) within the previously generated map. For example, since the last time the previously generated map was created or last updated, a certain feature may have fallen over, been removed, been repositioned, etc., such that the position of the certain feature now occupies a different position and/or coordinates in the present work area. The sensor assembly and/or the spatial locating device may facilitate determining the present position and/or coordinates in the present area. The controller 34 may update (process block 140) the previously generated map by repositioning (process block 144) only the certain feature that has been offset.

In some embodiments, the controller may update the previously generated map by repositioning (process block 144) only the feature(s) that have been offset when the percent of features determined to have been offset does not exceed a threshold percent of the total of features. In some embodiments, the feature is shifted on the previously generated map, for example, because the vehicle controller receives the first set of data and determines that the previous position or coordinates of the feature is not substantially similar to the present position or coordinates. In some embodiments, the vehicle controller may update the previous position or coordinates of the feature in response to determining that the feature is not within acceptable tolerances. For example, the tolerances may be based on a percent deviation from the position or coordinates of the previously generated map 31, such that the feature is not within an acceptable tolerance if the position or coordinates of the previously generated map 31 deviate more than a threshold distance or a percent of the threshold distance.

When one feature is determined to have been offset, removed, or added, and since one feature may be less than a threshold number or percentage of feature (e.g., three or 34%), the controller may reposition only those features which have been offset, removed, or added. As such, the updated map may differ from the previously generated map in that the updated map has been modified to reposition (process block 144) the one feature to reduce the one or more differences between previous and present positions or coordinates. In some embodiments, updating the previously generated map includes modifying the previously generated map to more closely match the present position or coordinates of the features in and boundaries of the work area. Alternatively or additionally, updating the previously generated map may reduce the one or more differences between the previous and present positions or coordinates. In further embodiments, the controller may update the map by performing any suitable actions, such as scaling the previously generated map, and/or removing, shifting, and/or adding certain features of the previously generated map, or any combination thereof, just to name a few.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A control system for a work vehicle, comprising:
a controller, comprising:
a processor; and
a memory device communicatively coupled to the processor and configured to store instructions, wherein the instructions when executed by the processor are configured to cause the processor to:
receive a first set of data indicative of a previously generated map of a work area, wherein the previously generated map comprises a previous position for each of a plurality of previously mapped features within the work area;
receive a second set of data indicative of a present position for each of a plurality of present features in the work area;
match the plurality of present features to the plurality of previous mapped features to determine at least one offset between the present position of at least one present feature of the plurality of present features and the previous position of a respective previously mapped feature of the plurality of previously mapped features;
determine a percentage of offsets based on a number of offsets of the determined at least one offset having a substantially similar offset distance and the number of the plurality of previously mapped features;
selectively shift the previously generated map of the work area to establish an updated map of the work area in response to the percentage of offsets exceeding a first threshold percentage; and
selectively shift the each of the plurality of previously mapped features to establish the updated map of the work area in response to the each of the plurality of previously mapped features being offset by more than a threshold distance and the percentage of offsets being less than the first threshold percentage.

2. The control system of claim 1, comprising a sensor assembly communicatively coupled to the controller, wherein the sensor assembly is configured to determine the plurality of present positions.

3. The control system of claim 2, comprising a spatial locating device communicatively coupled to the controller and configured to determine a present work vehicle position of the work vehicle, wherein the present position for each of the plurality of present features is determined relative to the present work vehicle position.

4. The control system of claim 1, wherein the instructions configured to cause the processor to selectively shift the previously generated map of the work area comprise instructions configured to cause the processor to shift a boundary defining the perimeter of the work area.

5. The control system of claim 1, wherein the at least one offset is considered to have the substantially similar offset distance when the at least one offset is within a predefined tolerance.

6. The control system of claim 1, wherein the predefined tolerance is 10 percent of the deviation from the respective previously mapped feature.

7. The control system of claim 1, wherein the first threshold percentage comprises a percentage value between 60 percent and 100 percent.

8. The control system of claim 1, wherein the instructions are configured to cause the processor to determine that a new feature has been added to the work area in response to determining that the second set of data comprises a new position for the new feature based on matching the present position of the at least one present feature of the plurality of present features to the previous position of the respective previously mapped feature of the plurality of previously mapped features, and the new position for the new feature is not present in the first set of data.

9. The control system of claim 8, wherein the instructions configured to cause the processor to generate an updated map comprise causing the processor to add the new feature to the previously generated map in response to the new position of the new feature not matching the respective previously mapped feature of the plurality of previously mapped features.

10. The control system of claim 1, wherein the instructions configured to selectively shift the each of the plurality of previously mapped features comprise aligning a previous boundary of the previously generated map to a present boundary of the updated map of the work area.

11. A method for updating a previously generated map of a work area, wherein a work vehicle is configured to operate in the work area, the method comprising:
receiving, via a controller, a first set of data indicative of the previously generated map of the work area, wherein the previously generated map comprises a previous position for each of a plurality of previously mapped features within the work area;
receiving, via the controller, a second set of data indicative of a present position for each of a plurality of present features in the work area;
matching, via the controller, the plurality of present features to the plurality of previous mapped features to determine at least one offset between the present position of at least one present feature of the plurality of present features and the previous position of a respective previously mapped feature of the plurality of previously mapped features;
determining, via the controller, a percentage of offsets based on a number of offsets of the determined at least one offset having a substantially similar offset distance and the number of the plurality of previously mapped features;
selectively shifting, via the controller, the previously generated map of the work area to establish an updated map of the work area in response to the percentage of offsets exceeding a first threshold percentage; and
selectively shifting, via the controller, the each of the plurality of previously mapped features to establish the updated map of the work area in response to the each of the plurality of previously mapped features being offset by more than a threshold distance and the percentage of offsets being less than the first threshold percentage.

12. The method of claim 11, comprising selectively scaling the previously generated map of the work area to reduce the at least one offset.

13. The method of claim 11, comprising determining, via the processor, that a previously mapped feature of the plurality of previously mapped features has been omitted from work area in response to determining that the second set of data omits at least one previous position corresponding to the previously mapped feature based on matching the present position of the at least one present feature of the plurality of present features and the previous position of the respective previously mapped feature of the plurality of previously mapped features, and wherein the corresponding position is not present in the second set of data.

14. The method of claim 13, wherein establishing the updated map comprises causing the processor to omit the previously mapped feature in the updated map in response to determining that the second set of data omits the previous position corresponding to the previously mapped feature.

15. The method of claim 11, wherein selectively shifting the each of the plurality of previously mapped features comprise aligning a previous boundary of the previously generated map to a present boundary of the updated map of the work area.

16. A system, comprising:
a first work vehicle comprising a first controller and a first sensor assembly, wherein the first work vehicle is configured to operate in a work area;
a second work vehicle comprising a second controller and a second sensor assembly, wherein the second work vehicle is configured to operate in the work area, wherein the second work vehicle is communicatively coupled to the first work vehicle, wherein the first controller and second controller are each configured to:
receive a first set of data indicative of a previously generated map of a work area, wherein the previously generated map comprises a previous position for each of a plurality of previously mapped features within the work area;
receive a second set of data indicative of a present position for each of a plurality of present features in the work area;
match the plurality of present features to the plurality of previous mapped features to determine at least one offset between the present position of at least one present feature of the plurality of present features and the previous position of a respective previously mapped feature of the plurality of previously mapped features;
determine a percentage of offsets based on a number of offsets of the determined at least one offset having a substantially similar offset distance and the number of the plurality of previously mapped features;
selectively shift the previously generated map of the work area to establish an updated map of the work area in response to the percentage of offsets exceeding a first threshold percentage; and
selectively shift the each of the plurality of previously mapped features to establish the updated map of the work area in response to the each of the plurality of previously mapped features being offset by more than a threshold distance and the percentage of offsets being less than the first threshold percentage.

17. The system of claim 16, wherein the instructions are configured to cause the processor to determine that a new feature has been added to the work area in response to determining that the second set of data comprises a new position for the new feature based on matching the present position of the at least one present feature of the plurality of present features to the previous position of the respective previously mapped feature of the plurality of previously mapped features, and the new position for the new feature is not present in the first set of data.

18. The system of claim 17, wherein the instructions configured to cause the processor to generate an updated map comprise causing the processor to add the new feature to the previously generated map in response to the new position of the new feature not matching the respective previously mapped feature of the plurality of previously mapped features.

19. The system of claim 17, wherein the new feature is not added to the updated map in response to determining that the new position of the new features substantially matches the position of the first or second work vehicle.

20. The system of claim 16, wherein the updated map is set to the previously generated map in response to the percentage of offsets being less than the first threshold percentage and the percentage of offset being less than the threshold distance.
